(19) United States
(12) Patent Application Publication
(10) Pub. No.: US 2015/0294334 A1
(43) Pub. Date: Oct. 15, 2015

(54) MODELING PROCEDURE COMBINING PURCHASE TRANSACTION DATA WITH SURVEY AND DEMOGRAPHIC DATA

(71) Applicant: MASTERCARD INTERNATIONAL INCORPORATED, Purchase, NY (US)

(72) Inventors: Shen Xi Ming, Millwood, NY (US); Po Hu, Norwalk, CT (US); Qian Wang, Ridgefield, CT (US)

(73) Assignee: MASTERCARD INTERNATIONAL INCORPORATED, Purchase, NY (US)

(21) Appl. No.: 14/249,754

(22) Filed: Apr. 10, 2014

(51) Int. Cl. G06Q 30/02

(52) U.S. Cl. CPC G06Q 30/0205; G06Q 30/0203

(57) ABSTRACT

Credit card transaction data sources are selectively linked with survey data sources and other external data sources to generate a data model for selected business applications. Transaction data at a customer level or at a geographic level may be linked with the survey data source. A survey data source may be configured for linking with a transaction data source to generate a model for export to external or internal processes. The survey data source may include linkages with the external data sources and/or with other internal data sources. Linkage models based on the transaction data may be incorporated in a financial data product or fed to downstream processes.

### FIELD OF TECHNOLOGY

The present disclosure relates to financial data processing and more particularly, to combining transaction data sources with survey data sources and external data sources to generate a data model for selected business applications.

### BACKGROUND

Many businesses utilize databases containing customer information and demographic information to perform market analysis, develop advertising campaigns, and perform other research. The databases used for such business purposes may generally be based on various data sources such as survey information, census information, and government statistics, for example.

Numerous laws and regulations have been passed by various jurisdictions, associations, and groups in an effort to increase consumer privacy. Such privacy laws have been detrimental to advertisers and merchants who had previously benefited from access to more detailed information about their customers and advertising targets. Certain credit card transaction data, for example, are protected by government regulations and/or industry standards for data security purposes. These protections may also prevent or hinder access to valuable insights contained in the transaction data and may prevent or hinder the merging of credit card transaction data with external sources such as survey data, demographic data, and social media data, for example.

### SUMMARY

Aspects of the present disclosure describe a method for linking information in protected credit card transaction data to external data sources. In one embodiment, the method for combining transaction and survey data includes receiving first transaction data descriptive of financial transactions of a first set of customers. The first transaction data is characterized in part by a first set of transaction data categories. The method also includes receiving survey data for a second set of customers, in which the survey data is characterized in part by the first set of transaction data categories. The second set of customers may include some or all customers in the first set of customers, or alternatively may be composed of a completely different set of customers. The survey data may include survey data categories selected for a first set of business applications, for example. The method also includes linking the first transaction data for a selected time period, for example, to the survey data in an electronic data processing system based on the first set of transaction data categories to generate a first linkage model to enable linking of protected financial transaction data sources to external data sources that may be unprotected and incorporating the linkage model in a financial data product.

A method for combining transaction and survey data according to another aspect of the present disclosure includes selecting a first set of transaction data categories included in a first set of transaction data. The first set of transaction data may be descriptive of financial transactions of a first set of customers, for example. The method also includes performing a survey including the first set of customers. In one embodiment, the survey collects survey data selected for a first set of business applications, in which the survey data includes the first set of transaction data categories. The method may also include linking the first set of transaction data to the survey data in an electronic data processing system based on the first set of transaction data categories to generate a first linkage model, and incorporating the linkage model in a financial data product.

Another aspect of the present disclosure includes a system for generating a linkage model based on credit card transaction data. The system includes a memory, at least one processor operatively coupled to the memory and a persistent storage device operatively coupled to the memory. The persistent storage device stores in a non-transitory manner instructions executable by the processor. The instructions may cause the processor to receive first transaction data descriptive of financial transactions of a first set of customers, in which the first transaction data is characterized in part by a first set of transaction data categories. The instructions may also cause the processor to receive survey data for the first set of customers, in which the survey data is characterized in part by the first set of transaction data categories. The survey data may include survey data categories selected for a first set of business applications, for example. The instruction may also cause the processor to link the first transaction data for a selected time period to the survey data based on the first set of transaction data categories to generate a first linkage model, and to incorporate the linkage model in a financial data product.

Another aspect of the present disclosure includes a system for generating a linkage model based on credit card transaction data in which instructions that are stored in a persistent storage device in a non-transitory manner, when loaded into a memory, cause one or more processors to select a first set of transaction data categories, in which the first set of transaction data categories is included in a first set of transaction data. The first set of transaction data may be descriptive of financial transactions of a first set of customers, and may be included in a protected transaction data source for example. The instructions may also cause the processor to perform a survey including the first set of customers, in which the survey data includes the first set of transaction data categories. In one embodiment, the survey may collect survey data selected for a first set of business applications, for example. The instructions may also link the first set of transaction data to the survey data in an electronic data processing system based on the first set of transaction data categories to generate a first linkage model, and incorporate the linkage model in a financial data product.

The following illustrates features and technical aspects of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspond aspects throughout.

FIG. 1 is a conceptual block diagram illustrating a general example of a credit card transaction system according to aspects of the present disclosure.

FIG. 2 is a block diagram illustrating a financial processing system according to an aspect of the present disclosure.

FIG. 3 is a conceptual block diagram illustrating processing of credit card transaction data according to an aspect of the present disclosure.

FIG. 4 is a conceptual block diagram illustrating a system for linking credit card transaction data to various other data sources according to aspects of the present disclosure.

FIG. 5 is process flow diagram illustrating a method for combining transaction data and survey data according to an aspect of the present disclosure.

FIG. 6 is a process flow diagram illustrating a method for generating a linkage model according to another aspect of the present disclosure.

FIG. 7 is a conceptual block diagram illustrating a system for linking data sources according to an aspect of the present disclosure.

### DETAILED DESCRIPTION OF EMBODIMENTS

Aspects of the present disclosure include a system and method for merging transaction data, such as protected customer-level credit card transaction data with survey data to generate a linkage model that can be incorporated in a financial data product while ensuring continued protection of the customer-level credit card transaction data. According to aspects of the present disclosure, a survey is configured to include one or more categories in common with standard customer-level transaction data. An example of a category of standard customer-level transaction data that may be included in a survey according to aspects of the present disclosure is an industry category, which identifies a corresponding financial transaction as being associated with a particular industry. An example of a survey that may be configured to generate data for merging with customer-level transaction data is a Comparative Cardholder Dynamics (CCD) survey by MasterCard Advisors of Purchase, N.Y. A CCD survey of financial customers can be configured according to aspects of the present disclosure to include set of industry categories that are generally included in standard customer-level transaction data. This facilitates merging the survey data with the customer-level transaction data based on industry categories. According to an aspect of the present disclosure, the resulting linkage model includes only data that is legally permitted to be combined with external data sources.

According to another aspect of the present disclosure, a survey may be configured to include one or more categories in common with standard geographic-level transaction data. An example of a category of standard geographic-level transaction data that may be included in a survey according to aspects of the present disclosure is a zip code category, which identifies a corresponding financial transaction as being associated with a particular geographic area. This facilitates merging the survey data with the geographic-level transaction data based on zip codes associated with the financial transactions. According to an aspect of the present disclosure, the resulting linkage model includes only data that is legally permitted to be combined with external data sources.

According to aspects of the present disclosure, a survey is configured to include one or more categories in common with standard customer-level transaction data and one or more categories in common with standard geographic-level transaction data. This facilitates merging the survey data with both the customer-level transaction data and the geographic-level transaction data.

According to another aspect of the present disclosure the survey is configured to generate survey data in categories selected for one or more particular business applications. The survey data may include financial dimensions, payment styles, payment channels, major merchant preferences, purchase intentions, attitudes toward a certain businesses, and opinions on certain social and economic issues associated with one or more industry categories and/or geographic areas, for example.

A survey such as a CCD survey may be coupled with external data sources such as credit data provided by Experian Information Solutions, Inc. of Dublin, Ireland, or marketing data provided by Acxiom of Little Rock, Ark., for example. This provides enhanced CCD survey data that can be merged with customer-level transaction data and/or geographic level transaction data according to aspects of the present disclosure.

According to aspects of the present disclosure, numerous financial modeling products can be implemented, exported to external sources and/or combined with external sources to satisfy various business requirements. For example, applications of a linkage model according to aspects of the present disclosure may facilitate modifications of existing modeling applications used by a financial service company, and/or implementation of various target applications derived from CCD survey data or from outside sources.

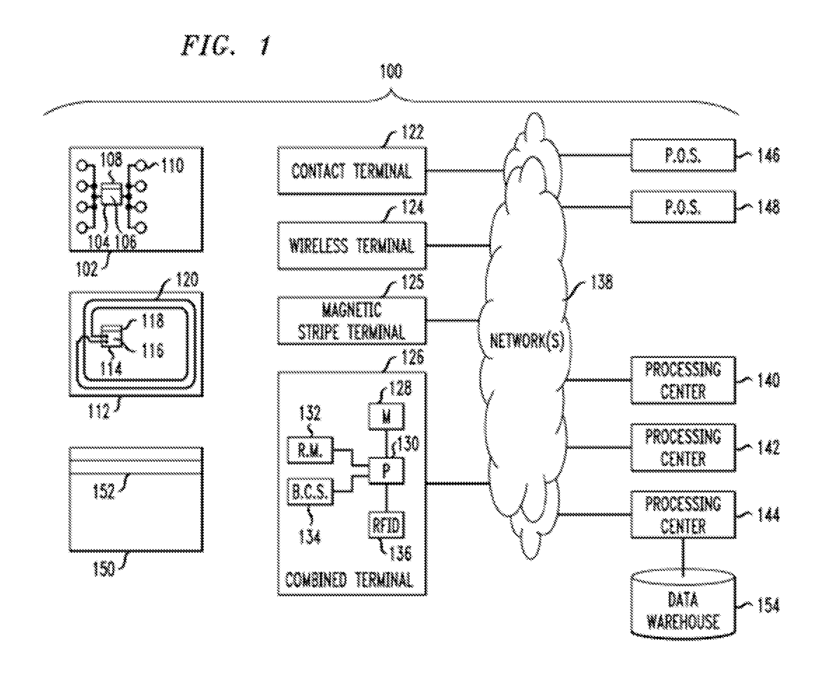

FIG. 1 depicts a system 100 including various possible components according to aspects of the present disclosure. It should be noted that for completeness and generality, presentation of certain physical cards such as known credit or debit cards to certain terminals will be described. However, aspects of the present disclosure involve credit accounts and transaction data that is not dependent on a physical card or terminal, for example. In FIG. 1, the system 100 includes a contact device such as card 102. Card 102 can include an integrated circuit (IC) chip 104 having a processor portion 106 and a memory portion 108. A plurality of electrical contacts 110 can be provided for communication purposes. In addition to or instead of card 102, system 100 can also be designed to work with a contactless device such as card 112. Card 112 can include an IC chip 114 having a processor portion 116 and a memory portion 118. An antenna 120 can be provided for contactless communication, such as, for example, using radio frequency (RF) electromagnetic waves. An oscillator or oscillators, and/or additional appropriate circuitry for one or more of modulation, demodulation, downconversion, and the like can be provided. Note that cards 102, 112 are exemplary of a variety of devices that can be employed for communicating transaction data according to aspects of the present disclosure. Other types of devices used in lieu of or in addition to “smart” or “chip” cards 102, 112 could include a conventional card 150 having a magnetic stripe 152, an appropriately configured cellular telephone handset, and the like. Indeed, techniques can be adapted to a variety of different types of cards, terminals, and other devices, configured, for example, according to a payment system standard (and/or specification).

The ICs 104, 114 can contain processing units 106, 116 and memory units 108, 118. Preferably, the ICs 104, 114 can also include one or more of control logic, a timer, and input/output ports. Such elements are well known in the IC art and are not separately illustrated. One or both of the ICs 104, 114 can also include a co-processor, again, well-known and not separately illustrated. The control logic can provide, in conjunction with processing units 106, 116, the control necessary to handle communications between memory unit 108, 118 and the input/output ports. The timer can provide a timing reference signal from processing units 106, 116 and the control logic. The co-processor could provide the ability to perform complex computations in real time, such as those required by cryptographic algorithms.

The memory portions or units 108, 118 may include different types of memory, such as volatile and non-volatile memory and read-only and programmable memory. The memory units can store protected transaction card data such as, e.g., a user's primary account number (“PAN”) and/or personal identification number (“PIN”). The memory portions or units 108, 118 can store the operating system of the cards 102, 112. The operating system loads and executes applications and provides file management or other basic card services to the applications. One operating system that can be used is the MULTOS® operating system licensed by MAOSCO Limited (MAOSCO Limited, St. Andrews House, The Links, Kelvin Close, Birchwood, Warrington, WA3 7PB, United Kingdom). Alternatively, JAVA CARD®-based operating systems, based on JAVA CARD® technology (licensed by Sun Microsystems, Inc., 4150 Network Circle, Santa Clara, Calif. 95054 USA), or proprietary operating systems available from a number of vendors, could be employed. Preferably, the operating system is stored in read-only memory (“ROM”) within memory portion 108, 118. In an alternate embodiment, flash memory or other non-volatile and/or volatile types of memory may also be used in the memory units 108, 118.

As noted, cards 102, 112 are examples of a variety of payment devices that can be employed. The primary function of the payment devices may not be payment, for example, they may be cellular phone handsets. Such devices could include cards having a conventional form factor, smaller or larger cards, cards of different shape, key fobs, personal digital assistants (PDAs) or tablets, appropriately configured cell phone handsets, or indeed any device with the appropriate capabilities. In some cases, the cards, or other payment devices, can include body portions (e.g., laminated plastic layers of a payment card, case or cabinet of a PDA, chip packaging, and the like), memories 108, 118 associated with the body portions, and processors 106, 116 associated with the body portions and coupled to the memories. The memories 108, 118 can contain appropriate applications. The processors 106, 116 can be operative to implement appropriate functionality. The applications can be, for example, application identifiers (AIDs) linked to software code in the form of firmware plus data in a card memory such as an electrically erasable programmable read-only memory (EEPROM). Again, note that “smart” or “chip” cards are not necessarily required and a conventional magnetic stripe card can be employed; furthermore, as noted above, one or more embodiments are of interest wherever credit is extended in a credit account, including accounts having no physical card.

A number of different types of terminals can be employed with system 100. Such terminals can include a contact terminal 122 configured to interface with contact-type device 102, a wireless terminal 124 configured to interface with wireless device 112, a magnetic stripe terminal 125 configured to interface with a magnetic stripe device 150, or a combined terminal 126. Combined terminal 126 is designed to interface with any type of device 102, 112, 150. Some terminals can be contact terminals with plug-in contactless readers. Combined terminal 126 can include a memory 128, a processor portion 130, a reader module 132, and optionally an item interface module such as a bar code scanner 134 and/or a radio frequency identification (RFID) tag reader 136. Items 128, 132, 134, 136 can be coupled to the processor 130. Note that the principles of construction of terminal 126 are applicable to other types of terminals and are described in detail for illustrative purposes. Reader module 132 can be configured for contact communication with card or device 102, contactless communication with card or device 112, reading of magnetic stripe 152, or a combination of any two or more of the foregoing (different types of readers can be provided to interact with different types of cards e.g., contacted, magnetic stripe, or contactless). Terminals 122, 124, 125, 126 can be connected to one or more processing centers 140, 142, 144 via a computer network 138. Network 138 could include, for example, the Internet, or a proprietary network (for example, a virtual private network, such as the BANKNET® virtual private network (VPN) of MasterCard International Incorporated of Purchase, N.Y., USA). More than one network could be employed to connect different elements of the system. For example, a local area network (LAN) could connect a terminal to a local server or other computer at a retail establishment. A payment network could connect acquirers and issuers. Further details regarding one specific form of payment network will be provided below. Processing centers 140, 142, 144 can include, for example, a host computer of an issuer of a payment device (or processing functionality of other entities discussed in other figures herein). Issuers can include issuers for cardless credit card accounts as well.

Many different retail or other establishments, as well as other entities, generally represented by points-of-sale 146, 148, can be connected to network 138. Different types of portable payment devices, terminals, or other elements or components can combine or “mix and match” one or more features depicted on the exemplary devices in FIG. 1.

Portable payment devices can facilitate transactions by a user with a terminal, such as 122, 124, 125, 126, of a system such as system 100. Such a device can include a processor, for example, the processing units 106, 116 discussed above. The device can also include a memory, such as memory portions 108, 118 discussed above, that is coupled to the processor. Further, the device can include a communications module that is coupled to the processor and configured to interface with a terminal such as one of the terminals 122, 124, 125, 126. The communications module can include, for example, the contacts 110 or antennas 120 together with appropriate circuitry (such as the aforementioned oscillator or oscillators and related circuitry) that permits interfacing with the terminals via contact or wireless communication. The processor of the apparatus can be operable to implement appropriate functionality. The processor can perform such operations via hardware techniques, and/or under the influence of program instructions, such as an application, stored in one of the memory units.

The portable device can include a body portion. For example, this could be a laminated plastic body (as discussed above) in the case of “smart” or “chip” cards 102, 112, or the handset chassis and body in the case of a cellular telephone or tablet.

Again, conventional magnetic stripe cards 150 can be used instead of or together with “smart” or “chip” cards, and again, cards and other payment devices are described for completeness, as one or more embodiments are of particular interest in the context of card-not-present Internet transactions.

It will be appreciated that the terminals 122, 124, 125, 126 are examples of terminal apparatuses for interacting with a payment device of a holder. The apparatus can include a processor such as processor 130, a memory such as memory 128 that is coupled to the processor, and a communications module 132 that is coupled to the processor and configured to interface with the portable apparatuses 102, 112, 142. The processor 130 can be operable to communicate with portable payment devices of a user via the communications module 132. The terminal apparatuses can function via hardware techniques in processor 130, or by program instructions stored in memory 128. Such logic could optionally be provided from a central location such as processing center 140 over network 138. The aforementioned bar code scanner 134 and/or RFID tag reader 136 can optionally be provided, and can be coupled to the processor, to gather attribute data, such as a product identification, from a UPC code or RFID tag on a product to be purchased.

The above-described devices 102, 112 can be ISO 7816-compliant contact cards or devices or NFC (Near Field Communications) or ISO 14443-compliant proximity cards or devices, for example. In operation, card 112 can be touched or tapped on the terminal 124 or 128, which then transmits the electronic data to the proximity IC chip in the card 112 or other wireless device. Magnetic stripe cards can be swiped in a well-known manner. In some instances, the card number is simply provided via web site, in a card-not present transaction or the like.

One or more of the processing centers 140, 142, 144 can include a database such as a data warehouse 154; for example, to hold transaction data as described below. It should be understood by persons skilled in the relevant arts that a database or data warehouse 154 may be directly linked to the one or more processing centers 140, 142, 144 or may be linked to the processing centers via the network(s) 138, for example.

In the context of card-not-present Internet transactions, the card or other device is not presented to terminal 122, 124, 125, or 126. Rather, appropriate account information (e.g., primary account number (PAN), cardholder name, cardholder address, expiration date, and/or security code, and so on) is provided to a merchant by a consumer using a web site or the like. The merchant then uses this information to initiate the authorization process.

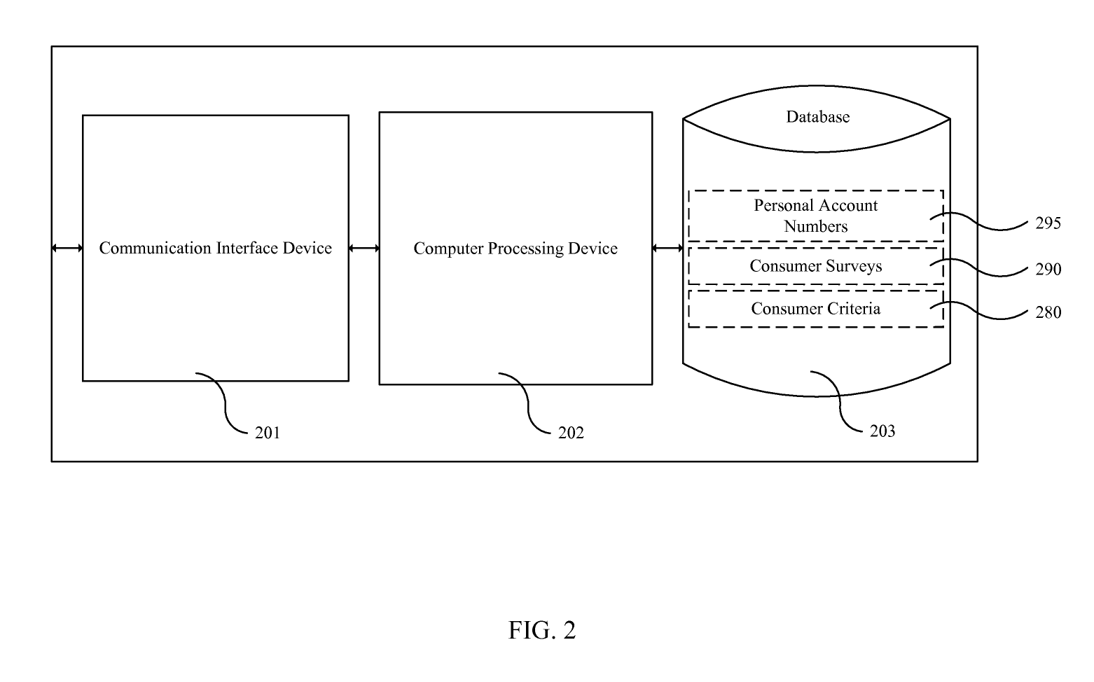

FIG. 2 is a block diagram illustrating a financial processing system 200 according to an embodiment of the disclosed system. The financial processing system may be implemented in one or more processing centers 140, 142, 144 (illustrated in FIG. 1). The financial processing system 200 includes a communication interface device 201, a computer processing device 202, and a database 203.

The communication interface device 201 of the financial processing system 200 provides one or more communication paths from the financial processing system to and from other systems. For example, the communication interface device 201 can provide a communication path to or from a communication network 138 (illustrated in FIG. 1) or to or from a point of sale 146, 148 (illustrated in FIG. 1). Types of communication paths utilized by the communication interface device 201 will be apparent to persons having skill in the relevant art(s). The communication interface device 201 may be configured to send and receive transaction authorizations, to send and receive approval or denial notifications, and to send and receive transaction information, for example.

The computer processing device 202 of the financial processing system 200 may be configured to receive transaction data from the points of sale 146, 148, via the communication interface device 201 and/or to communicate with the database 203. The computer processing device 202 can be any type of processing device that is suitable for performing the functions discussed herein, such as a central processing unit (CPU), a personal computer, an array of a plurality of CPUs or personal computers, or any other processing device. The computer processing device 202 can operate via implementations of hardware, of software, or of a combination of both hardware and software. The types of computer processing devices and methods for carrying out the processing will be apparent to persons having skill in the relevant art(s).

The database 203 of the financial processing system 200 may be included in the data warehouse 154 (illustrated in FIG. 1) and/or may be included in one or more of the processing centers 140, 142, 144 (illustrated in FIG. 1), for example. The database 203 is configured to store a variety of information pertaining to the financial processing system 200. For example, the database 203 may be configured to store personal account numbers 295 (associated with financial cards) of consumers, as well as general and merchant-specific spending and response characteristics of consumers linked to their personal account numbers. Additionally, the database 203 may be configured to store consumer profiles, including information provided by the consumers. Such information can include, e.g., name, contact information, preferred modes of electronic communication.

Although the database 203 is illustrated in FIG. 2 as being external to the computer processing device 202, it should be understood that in alternative embodiments the database 203 may be implemented within the computer processing device 202, for example. The type of database used may include a relational database management system (RDBMS). Methods of storing and accessing the information in the database will be apparent to persons having skill in the relevant art(s). For example, a query language such as Standardized Query Language (SQL) can be used for storing and accessing the information in the database according to aspects of the present disclosure.

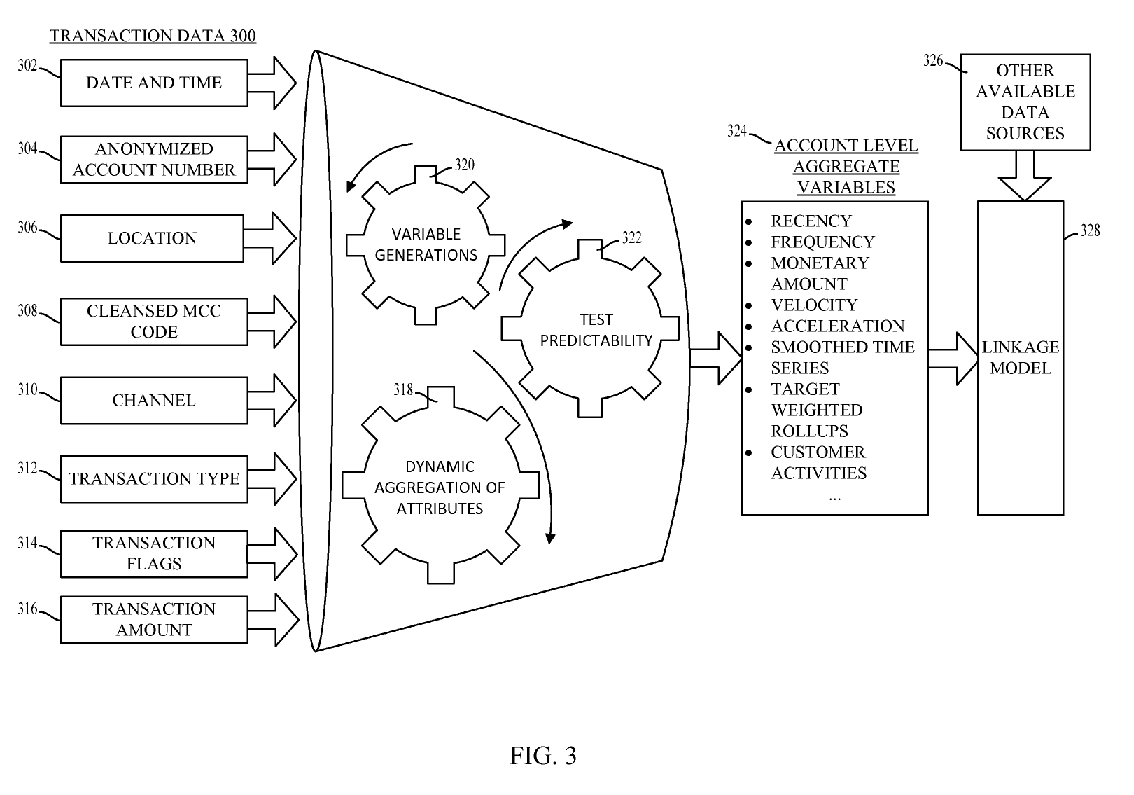

FIG. 3 depicts the construction of certain customer level transaction input variables according to an aspect of the present disclosure. Transaction data 300 may be gathered for some suitable period of time. In one example a suitable period of time for gathering the transaction data is 24 months. In some instances, transaction data 300 from one or more processing systems is loaded into a data warehouse to collect, transform and summarize the data, for example. As shown in FIG. 3, examples of the transaction data 300 include date and time information 302, anonymized account numbers 304, location information 306, cleansed merchant category codes (MCC) 308, channel information 310, transaction types 312, transaction flags 314, and/or transaction amounts 316. The anonymized account numbers 304 may be an anonymous identifier representing a credit card number that is not personally traceable to a card holder, for example. One well-known example of an MCC 308 is a four-digit number assigned to a business by the operator of a payment network such as MasterCard International Incorporated or other operators of a payment network when the business first starts accepting cards associated with a corresponding payment networks as a form of payment. The MCC 308 may classify the business by the type of goods or services it provides, for example. The term “cleansed merchant category code (MCC)” as used herein refers to an MCC which has been subject to some level of error checking. For example, a received MCC may be checked against other received data and corrected if the received MCC is inconsistent with the other received data.

In one example, the transaction data 300 is processed to generate account level aggregate variables 324. This processing of the transaction data may include dynamic aggregation of attributes 318, variable generation 320 and/or predictability testing 322, for example. According to aspects of the present disclosure, the account level aggregate variables 324 capture multiple dimensions of transactions at an industry level, an MCC level, and a merchant level, for example. The account level aggregate variables 324 may include, recency (i.e. time since last transaction), frequency, monetary amount, velocity, acceleration, smoothed time series, target weighted roll-ups, timing (e.g., weekend versus weekday spending), the ratio over the total spend (e.g., percentage spend in retail versus total spending) and/or certain customer activities, for example. According to aspects of the present disclosure some or all of the transaction data 300 and/or the account level aggregate variables 324 may be combined with other available data sources 326 in a linkage model 328.

Transactional data is typically standardized and more reliable than self-reported data such as survey data for example. Moreover, certain information regarding purchase transaction behavior that may be unavailable elsewhere is generally embedded in transaction data. According to aspects of the present disclosure, transaction data, which generally needs to be protected and is generally inaccessible, can be linked with other available data sources such as survey data, credit card issuer data, credit bureau data, social media data and/or other third party data sources to gain valuable financial insights. A linkage model that is generated by combining various data sources with transaction data according to aspects of the present disclosure may include previously unavailable transaction information providing valuable insight with respect to particular products, industry categories, customer behaviors, consumer account balances held with one or more issuers, demographic information and complex transaction behavior patterns, for example. Business applications that may benefit from access to a credit card transaction data linkage model according to aspects of the present disclosure include targeted advertising and financial risk analysis applications, for example.

Referring still to FIG. 3, according to aspects of the present disclosure the aggregation may include transforming transaction level data into account level data, creating new variables, cleaning the data, and/or aggregating the merchants into merchant categories, for example. These processes can be carried out, for example, using commercial software and databases. Examples of suitable software include the IBM NETEZZA® data warehouse appliance (registered mark of IBM INTERNATIONAL GROUP BV LIMITED LIABILITY COMPANY, AMSTERDAM NETHERLANDS), SAS® software (registered mark of SAS Institute Inc., SAS Campus Drive, Cary, N.C. 27513, USA), and the SQL (Structured Query Language) programming language designed for managing data in relational database management systems (RDBMS).

The aggregation may also include aggregating transaction level elements, such as time, amount, location, merchant and/or MCC data; at the account level to create account level variables that capture appropriate information. Account level data may be useful to characterize purchasing behavior of an account holder or make predictions regarding an account holder, for example.

Certain credit card transaction data may be protected by privacy laws, government regulations and/or industry standards. For example, the Payment Card Industry Data Security Standards (PCI DSS) is an industry standard that requires stored cardholder data to be protected and restrict access to cardholder data. These protections may prevent or hinder access to valuable insights contained in transaction data and may prevent or hinder the merging of credit card transaction data with external sources such as survey data, demographic data, and social media data, for example. Aspects of the present disclosure describe a method for linking information in protected credit card transaction data to external data sources. Practical techniques are disclosed that may be implemented individually or combined to build a comprehensive system for linking the credit card transaction data to the external sources.

A linkage model is a framework that can be used to identify relationships between different data sets based on information about a common entity that is represented in each data set. By combining data sets according to a linkage model, particular records in a first data set may be linked to or merged with corresponding records in a second data set. The corresponding records may include information about a common entity such as an individual, company, geographic region, family, or household, for example. A linkage model may identify particular attributes, fields or parameters that are included in both data sets or may define a statistical or probabilistic relationship between particular attributes in the data sets which allow linking or merging the data sets, for example. A linkage model may also map numerous linkages for combining numerous data sets and may define numerous intermediate linkages between data sets and/or a final linkage between data sets. The various attributes of interest and their statistical relationships as well as other insights obtained by the implementing a linkage model may be considered as outputs of the linkage model, also referred to herein as “targets.”

Linkage models are commonly used to assist decision making in the fields of financial analysis and marketing, for example. Various linkage models may be used to determine how various geographic areas are statistically related, or to statistically characterize various causes of certain consumer behaviors, for example. In such applications of a linkage model, a target may include parameters that have been identified to have a significant statistical effect on some other parameters of interest. Marketing campaigns or research initiatives may be directed to focus on targets that are generated according to various linkage models, for example. In other applications of a linkage mode, an improved data set may be generated and provided as input to some downstream process. The downstream process may also include implementation of further linkage models, for example.

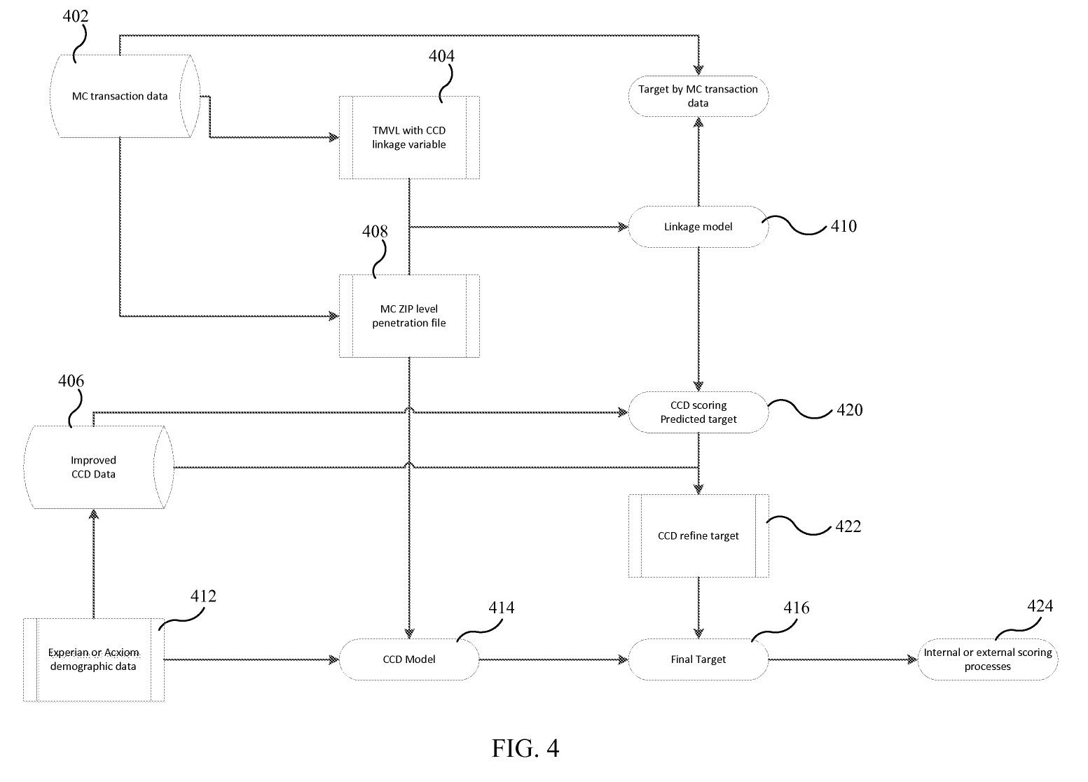

Referring to FIG. 4, credit card transaction data 402 includes customer level transaction data and/or geographic level transaction data. A first technique for linking credit card transaction data 402 to external data sources according to aspects of the present disclosure includes creating a first linkage 404 (i.e. linked data set) by using a first linkage model that is based on individual consumer level transaction data. According to the first linkage model, the linkage 404 may be created by matching a set of industry categories, such as MCA industry categories in the transaction data 402 with corresponding categories in survey data such as MCA survey data 406 (e.g., Comparative Cardholder Dynamics (CCD)). This generates a bridge linking consumer level transaction data (e.g. MCA consumer level data) with survey data (e.g. CCD data) or other internal data for example.

A second technique for linking credit card transaction data to external data sources according to aspects of the present disclosure includes creating a second linkage 408 by using a second linkage model that is based on geographic level transaction data. According to the second linkage model, the second linkage 408 may be created by matching geographic information, such as zip codes, in the transaction data 402 with corresponding geographic information, such as zip codes, in the survey data 406. This generates a bridge linking geographic level transaction data (e.g. MCA zip level data) with survey data (e.g. CCD data) or other internal data for example. It should be understood that the second technique may be performed independently of the first technique and vice versa.

According to aspects of the present disclosure, a third linkage 410 may be created using a third linkage model that accesses the customer level transaction data via the first linkage 404 and accesses zip level transaction data via the second linkage 408. According to one aspect of the present disclosure, the survey data 406 and or other internal data sources may be combined with the transaction data 402 using any one or combination of the first linkage 404, the second linkage 408 or the third linkage 410. After being combined with the survey data 406 and or other internal data sources, transaction data 402 becomes accessible for combining with outside data sources 412. Thus, combining the transaction data 402 with survey data 406 and or other internal data sources according to aspects of the present disclosure generates a bridge linking consumer level transaction data (e.g. MCA consumer level data) and/or geographic level transaction data (e.g. MCA zip level data) with outside data sources 412. According to an embodiment the present disclosure, the first linkage 404, second linkage 408 and/or third linkage 410 may be defined to exclude access to portions of the transaction data 402 that may be protected, and/or to enforce data protection by encryption, or some other means, for example.

According to another aspect of the present disclosure, the resulting linkage model(s) may be further combined with outside data sources (ODS) to create a fourth linkage model 414. Certain survey data 406 such as CCD data is already linked with outside data sources such as credit data provided by Experian Information Solutions, Inc. of Dublin, Ireland, or marketing data provided by Acxiom of Little Rock, Ark., for example. By creating a link between transaction data 402 and outside data sources (ODS) 412 according to aspects of the present disclosure, a deliverable data product, such as a final target 416 may be provided to an external process 417 or another internal process, for example. The deliverable data product may include a financial product such an MCA product or target data for advertising or marketing applications, which are enhanced by the disclosed linkages to valuable transaction information. According to aspects of the present disclosure, additional deliverable outputs may also be provided at intermediate stages including any combination of the disclosed linkage models. For example, the third linkage model 410 may be used to generate a first intermediate target output 418 that is based on transaction data 402 or a second intermediate target output 420 that is based on the survey data 406. The second intermediate target output 420 may be used to refine the survey data 406 and generate a refined survey data set 422 that may be output to an internal or external process 422 directly or after generating the output 416 based on the fourth linkage model 414, for example.

According to aspects of the present disclosure one or more surveys may be designed and/or implemented to collect particular survey data for linking with corresponding transaction data. For example, an appropriate survey design to be implemented according to aspects of the present disclosure should include particular linkage information, such as industry categories and zip codes for bridging with transaction data such as MCA transaction data. According to another aspect of the present disclosure, a survey may also be designed and/or implemented to collect information that is based on particular applications of a related business target. The information collected by a survey according to aspects of the present disclosure may include financial dimensions, payment styles, payment channels, major merchant preferences, purchase intentions, consumer attitudes toward certain businesses and/or consumer opinions regarding social and economic issues, for example.

The survey data generated according to aspects of the present disclosure can be targeted by various modeling projects for different business needs. For example, by combining survey data such as CCD data based on appropriately designed surveys with credit card transaction data such as MCA data, financial information can be extracted to develop risk models for banks, intention data can be extracted to generate intent-action gap models for merchants or media enterprises, and merchant preferences can be extracted to generate direct-mail or -email models for different businesses.

According to aspects of the present disclosure, credit card transaction data such as MCA transaction data at a consumer level and/or at a geographic level is linked with survey data such as CCD data, and/or with other internal data and/or with outside data sources (ODS) in a comprehensive linkage model (e.g., MCA-CCD-ODS linkage model). The disclosed comprehensive linkage model facilitates the creation of previously unavailable of data sets and analysis tools. The data sets and analysis tools generated by implementing the disclosed linkage models can be combined or incorporated with existing financial information products or may be provided as stand-alone information products, for example. According to aspects of the present disclosure, targets generated from combining survey data, other internal data sources and/or outside data sources combined with transaction data may include particular factors or data attributes that are found to be significantly influential on other factors or attributes of interest. The comprehensive linkage system including the linkage models disclosed herein provides a functional platform for implementing information products, generating targets and/or delivering the information products and targets to business applications. The disclosed linkage models may be used as tools to apply merchant management strategies, media strategies and/or risk management strategies to a general consumer base.

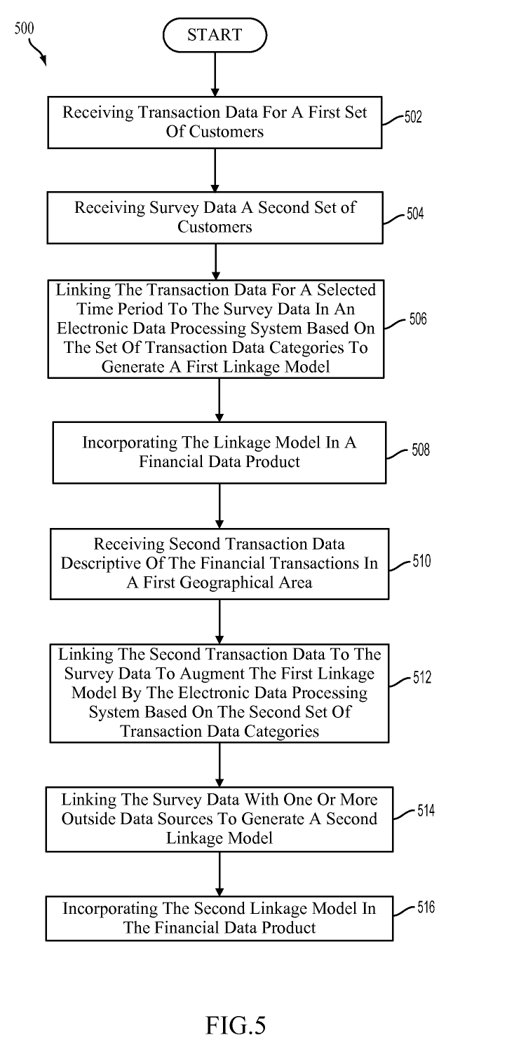

A method for combining transaction data and survey data according to an aspect of the present disclosure is described with reference to FIG. 5. The method 500 includes receiving transaction data for a first set of customers at block 502 and receiving survey data for a second set of customers at block 504. The second set of customers may include some or all customers in the first set of customers, or alternatively may be composed of completely different set of customers. The transaction data is descriptive of financial transactions of the set of customers and is characterized in part by a set of transaction data categories. The survey data is characterized in part by the same set of transaction data categories. In one example, the set of transaction data categories includes standard industry categories. The survey data may be linked to one or more outside data sources.

According to another aspect of the present disclosure, the survey data also includes survey data categories selected for a first set of business applications. The survey data categories selected for the first set of business applications may include financial dimension, payment style, payment channel, major merchant preference, purchase intention, attitudes toward certain businesses, and opinions on certain social and economic issues, for example.

At block 506, the method includes linking the transaction data for a selected time period to the survey data in an electronic data processing system based on the set of transaction data categories to generate a first linkage model. At block 508, the method includes incorporating the linkage model in a financial data product.

According to an aspect of the present disclosure, at block 510, the method may also include receiving second transaction data descriptive of the financial transactions in a first geographical area. The second transaction data and the survey data are characterized in part by a second set of transaction data categories. At block 512, the method may include linking the second transaction data to the survey data to augment the first linkage model by the electronic data processing system based on the second set of transaction data categories. In one example, the second set of transaction data categories includes a zip code category.

According to another aspect of the present disclosure, at block 514, the method includes, linking the survey data with one or more outside data sources to generate a second linkage model. At block 516, the method may include incorporating the second linkage model in the financial data product.

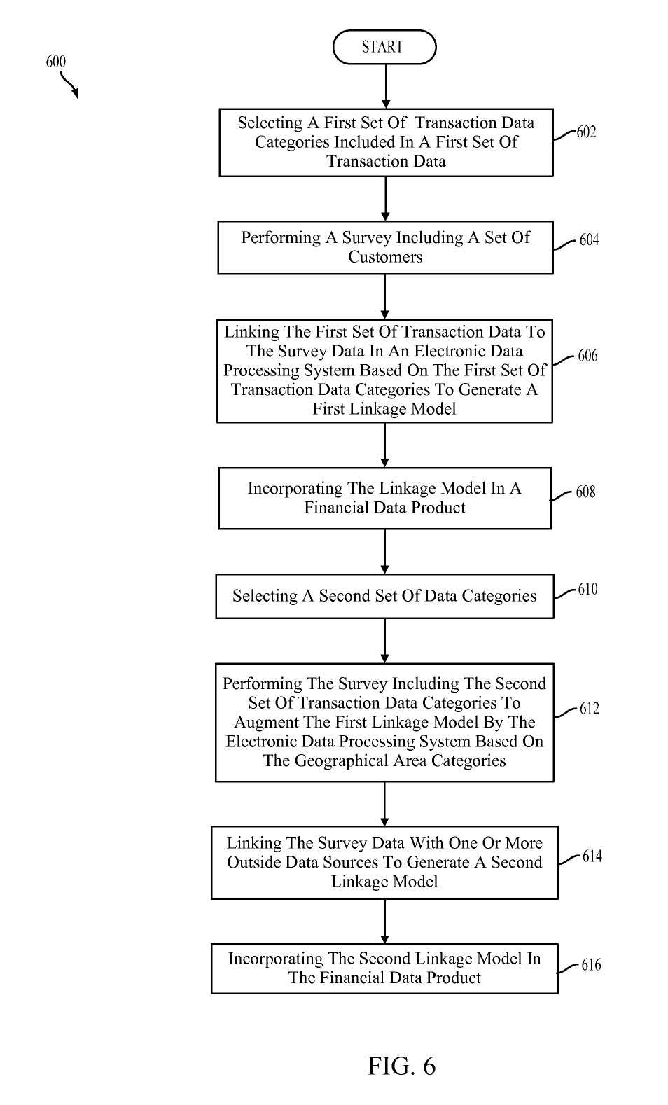

A method for generating a linkage model according to another aspect of the present disclosure is described with reference to FIG. 6. The method 600 includes selecting a first set of transaction data categories included in a first set of transaction data at block 602. The first set of transaction data is descriptive of financial transactions of a first set of customers. At block 604, the method includes performing a survey including a second set of customers. The second set of customers may include some or all customers in the first set of customers, or alternatively may be composed of a completely different set of customers. The survey collects survey data selected for a first set of business applications in which the survey data includes the first set of transaction data categories.

At block 606, the method includes linking the first set of transaction data to the survey data in an electronic data processing system based on the first set of transaction data categories to generate a first linkage model. At block 608, the method includes incorporating the linkage model in a financial data product.

According to an aspect of the present disclosure, the method shown in FIG. 6 may also include selecting a second set of transaction data categories at block 610. The second set of transaction data categories is included in the first set of transaction data and characterizes the financial transactions by geographical area. At block 612, the method includes performing the survey including the second set of transaction data categories to augment the first linkage model by the electronic data processing system based on the geographical area categories. At block 614, the method includes linking the survey data with one or more outside data sources to generate a second linkage model, and at block 616, the method includes incorporating the second linkage model in the financial data product.

Embodiments of the present disclosure can employ hardware and/or hardware and software aspects. Referring to FIG. 1, software may include firmware, resident software, microcode, etc. Software may be employed, for example, in connection with one or more of a terminal 122, 124, 125, 126; a reader 132; payment devices such as cards 102, 112; a host, server, and/or processing center 140, 142, 144 (optionally with data warehouse 154) of a merchant, issuer, acquirer, processor, or operator of a network 138 operating according to a payment system standard (and/or specification), for example. Firmware may be employed, for example, in connection with payment devices such as cards 102, 112 and reader 132. Firmware provides a number of basic functions (e.g., display, print, accept keystrokes) that in themselves do not provide the final end-use application, but rather are building blocks; software links the building blocks together to deliver a usable solution.

Accordingly, it will be appreciated that one or more embodiments of the present disclosure can include a computer program comprising computer program code means adapted to perform some or all of the steps of any methods or claims set forth herein when such program is run on a computer, and that such program may be embodied on a computer readable medium. Further, one or more embodiments of the present disclosure can include a computer comprising code adapted to cause the computer to carry out one or more steps of methods or claims set forth herein, together with one or more apparatus elements or features as depicted and described herein.

Computers discussed herein can be interconnected, for example, by one or more of a network, another virtual private network (VPN), the Internet, a local area and/or wide area network (LAN and/or WAN), via an EDI layer, and so on. The computers can be programmed, to implement the logic depicted in the flow charts and other figures.

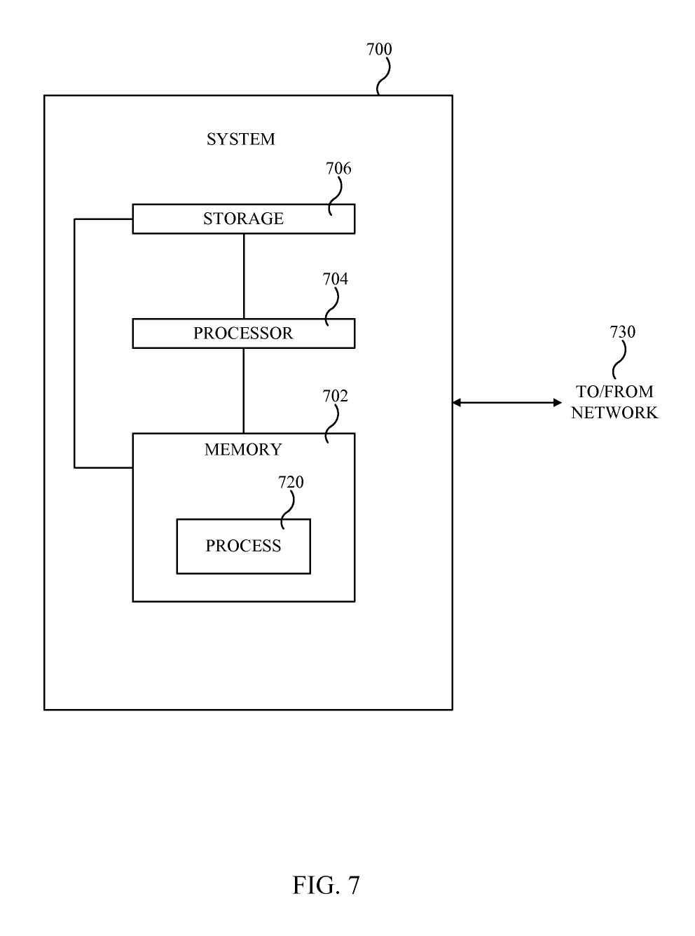

A system for linking data sources according to an aspect of the present disclosure is described with reference to FIG. 7. The system 700 includes a memory 702, at least one processor 704 operatively coupled to the memory 702. The system 700 also includes a persistent storage device 706, which is operatively coupled to the memory 702 and/or to the processor(s) 704. The memory 702 is cooperative with the processor 704 to implement one or more aspects of the methods, steps and functions disclosed herein (collectively, shown as process 720). The system 700 may be coupled to various data sources directly or via a network interface 730, for example.

According to an aspect of the present disclosure, the persistent storage device 706 stores, in a non-transitory manner, instructions which when loaded into the memory 702, cause the processor(s) 704 to be operative to receive first transaction data descriptive of financial transactions of a first set of customers, in which the first transaction data is characterized in part by a first set of transaction data categories. The first set of transaction data categories may include standard industry categories, for example.

The instructions when loaded into the memory 702 also cause the processor(s) 704 to receive survey data for the first set of customers, in which the survey data is also characterized in part by the first set of transaction data categories. According to an aspect of the disclosure, the survey data also includes survey data categories selected for a first set of business applications. The instructions when loaded into the memory 702 also cause the processor(s) 704 to link the first transaction data, for example for a selected time period, to the survey data based on the first set of transaction data categories to generate a first linkage model, and to incorporate the linkage model in a financial data product such as described above. The survey data may be linked to one or more outside data sources. The survey data categories that are selected for the first set of business applications may include financial dimensions, payment styles, payment channels, major merchant preferences, purchase intentions, attitudes toward a certain businesses, and/or opinions on certain social and economic issues, for example.

According to another aspect of the present disclosure, the instructions when loaded into the memory 702 also cause the processor(s) 704 to receive second transaction data descriptive of the financial transactions in a first geographical area, in which the second transaction data and the survey data are characterized in part by a second set of transaction data categories. The instructions when loaded into the memory 702 may also cause the processor(s) 704 to link the second transaction data to the survey data to augment the first linkage model based on the second set of transaction data categories. The second set of transaction data categories may include a zip code category, for example.

According to another aspect of the present disclosure, the instructions when loaded into the memory 702 also cause the processor(s) 704 to link the survey data with one or more outside data sources to generate a second linkage model, and to incorporate the second linkage model in the financial data product.

According to an aspect of the present disclosure, the persistent storage device 706 stores, in a non-transitory manner, instructions which when loaded into the memory 702, cause the processor(s) 704 to be operative to select a first set of transaction data categories that are included in a first set of transaction data, in which the first set of transaction data is descriptive of financial transactions of a first set of customers. The instructions when loaded into the memory 702 also cause the processor(s) 704 to perform a survey including the first set of customers, in which the survey collects survey data selected for a first set of business applications and in which the survey data includes the first set of transaction data categories. According to this aspect of the present disclosure, the instructions when loaded into the memory 702 also cause the processor(s) 704 to link the first set of transaction data to the survey data in an electronic data processing system based on the first set of transaction data categories to generate a first linkage model, and incorporate the linkage model in a financial data product.

According to another aspect of the present disclosure, the instructions when loaded into the memory 702 may also cause the processor(s) 704 to select a second set of transaction data categories which categorize the financial transactions by geographical area, and to perform the survey including the second set of transaction data categories to augment the first linkage model by the electronic data processing system based on the geographical area categories.

According to another aspect of the present disclosure, the instructions when loaded into the memory 702 may also cause the processor(s) 704 to link the survey data including the second set of transaction data categories with one or more outside data sources to generate a second linkage model and incorporate the second linkage model in the financial data product.

Embodiments of the present disclosure are described herein with reference to the accompanying drawings. However, the present disclosure should not be construed as limited to the embodiments set forth herein. Rather, these embodiments are provided so that this disclosure will be thorough and complete, and will fully convey the scope of the present disclosure to those skilled in the art. Like numbers refer to like elements throughout. As used herein the term “and/or” includes any and all combinations of one or more of the associated listed items and may be abbreviated as “/”.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “having,” “having,” “includes,” “including” and/or variations thereof, when used in this specification, specify the presence of stated features, steps, operations, elements, and/or components, but do not preclude the presence or addition of one or more other features, steps, operations, elements, components, and/or groups thereof.

It should be understood that when an element is referred to as being “connected” or “coupled” to another element (or variations thereof), it can be directly connected or coupled to the other element or intervening elements may be present. In contrast, when an element is referred to as being “directly connected” or “directly coupled” to another element (or variations thereof), there are no intervening elements present.

It will be understood that, although the terms first, second, etc. may be used herein to describe various elements and/or components, these elements and/or components should not be limited by these terms. These terms are only used to distinguish one element and/or component from another element and/or component. Thus, a first element or component discussed below could be termed a second element or component without departing from the teachings of the present disclosure.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Although the present disclosure has been described in connection with the embodiments of the present disclosure illustrated in the accompanying drawings, it is not limited thereto. The above-disclosed subject matter is to be considered illustrative, and not restrictive, and the appended claims are intended to cover all such modifications, enhancements, and other embodiments, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Although specific components have been set forth, it will be appreciated by those skilled in the art that not all of the disclosed components are required to practice the disclosed configurations. Moreover, certain well known components have not been described, to maintain focus on the disclosure.

For a firmware and/or software implementation, the methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular configurations of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

What is claimed is:

1. A method comprising:
receiving first transaction data descriptive of financial transactions of a first set of customers, the first transaction data characterized in part by a first set of transaction data categories;
receiving survey data for a second set of customers, the survey data characterized in part by the first set of transaction data categories, the survey data including survey data categories selected for a first set of business applications;
linking the first transaction data for a selected time period to the survey data in an electronic data processing system based on the first set of transaction data categories to generate a first linkage model; and
incorporating the linkage model in a financial data product.

2. The method of claim 1, wherein the first set of transaction data categories includes standard industry categories.

3. The method of claim 1, further comprising:
receiving second transaction data descriptive of the financial transactions in a first geographical area, the second transaction data and the survey data characterized in part by a second set of transaction data categories; and
linking the second transaction data to the survey data to augment the first linkage model by the electronic data processing system based on the second set of transaction data categories.

4. The method of claim 3, wherein the second set of transaction data categories includes a zip code category.

5. The method of claim 1, wherein the survey data is linked to one or more outside data sources.

6. The method of claim 1, further comprising, linking the survey data with one or more outside data sources to generate a second linkage model; and
incorporating the second linkage model in the financial data product.

7. The method of claim 1, wherein the survey data categories selected for the first set of business applications are in the group consisting of: financial dimension, payment style, payment channel, major merchant preference, purchase intention, attitudes toward a certain businesses, and opinions on certain social and economic issues.

8. A method comprising:
selecting a first set of transaction data categories, the first set of transaction data categories included in a first set of transaction data, the first set of transaction data descriptive of financial transactions of a first set of customers;
performing a survey including a second set of customers, the survey collecting survey data selected for a first set of business applications, the survey data including the first set of transaction data categories; and
linking the first set of transaction data to the survey data in an electronic data processing system based on the first set of transaction data categories to generate a first linkage model; and
incorporating the linkage model in a financial data product.

9. The method of claim 8, further comprising:
selecting a second set of transaction data categories, the second set of transaction data categories included in the first set of transaction data, the second set of transaction data categories characterizing the financial transactions by geographical area; and
performing the survey including the second set of transaction data categories to augment the first linkage model by the electronic data processing system based on the geographical area categories.

10. The method of claim 8, further comprising, linking the survey data with one or more outside data sources to generate a second linkage model; and
incorporating the second linkage model in the financial data product.

11. A system comprising:
a memory;
at least one processor operatively coupled to the memory; and
a persistent storage device operatively coupled to the memory and storing in a non-transitory manner instructions which when loaded into the memory cause the at least one processor to be operative to:
receive first transaction data descriptive of financial transactions of a first set of customers, the first transaction data characterized in part by a first set of transaction data categories;
receive survey data for a second set of customers, the survey data characterized in part by the first set of transaction data categories, the survey data including survey data categories selected for a first set of business applications;
link the first transaction data for a selected time period to the survey data based on the first set of transaction data categories to generate a first linkage model; and
incorporate the linkage model in a financial data product.

12. The system of claim 11, wherein the first set of transaction data categories includes standard industry categories.

13. The system of claim 11, wherein the survey data is linked to one or more outside data sources.

14. The system of claim 11, wherein the survey data categories selected for the first set of business applications are in the group consisting of: financial dimension, payment style, payment channel, major merchant preference, purchase intention, attitudes toward a certain businesses, and opinions on certain social and economic issues.

15. The system of claim 11, wherein the persistent storage device further stores in a non-transitory manner instructions which when loaded into the memory cause the at least one processor to be operative to:
receive second transaction data descriptive of the financial transactions in a first geographical area, the second transaction data and the survey data characterized in part by a second set of transaction data categories; and
link the second transaction data to the survey data to augment the first linkage model based on the second set of transaction data categories.

16. The system of claim 15 wherein the second set of transaction data categories includes a zip code category.

17. The system of claim 11, wherein the persistent storage device further stores in a non-transitory manner instructions which when loaded into the memory cause the at least one processor to be operative to link the survey data with one or more outside data sources to generate a second linkage model; and
incorporate the second linkage model in the financial data product.

18. A system comprising:
a memory;
at least one processor operatively coupled to the memory; and
a persistent storage device operatively coupled to the memory and storing in a non-transitory manner instructions which when loaded into the memory cause the at least one processor to be operative to:
select a first set of transaction data categories, the first set of transaction data categories included in a first set of transaction data, the first set of transaction data descriptive of financial transactions of a first set of customers;
perform a survey including a second set of customers, the survey collecting survey data selected for a first set of business applications, the survey data including the first set of transaction data categories; and
link the first set of transaction data to the survey data in an electronic data processing system based on the first set of transaction data categories to generate a first linkage model; and
incorporate the linkage model in a financial data product.

19. The system of claim 18, wherein the persistent storage device further stores in a non-transitory manner instructions which when loaded into the memory cause the at least one processor to be operative to:
select a second set of transaction data categories, the second set of transaction data categories included in the first set of transaction data, the second set of transaction data categories characterizing the financial transactions by geographical area; and
perform the survey including the second set of transaction data categories to augment the first linkage model by the electronic data processing system based on the second set of transaction data categories.

20. The system of claim 18, wherein the persistent storage device further stores in a non-transitory manner instructions which when loaded into the memory cause the at least one processor to be operative to:
link the survey data with one or more outside data sources to generate a second linkage model; and
incorporate the second linkage model in the financial data product.
